(19) United States
(12) Patent Application Publication
(10) Pub. No.: US 2005/0171298 A1
(43) Pub. Date: Aug. 4, 2005

(54) Pyrrolidone, piperidone and azetidinone terminated and functionalizes dendritic polymers

(76) Inventors: Donald A. Tomalia, Midland, MI (US); Douglas R. Swanson, Mt. Pleasant, MI (US); Baohua Huang, Mt. Pleasant, MI (US)

Correspondence Address: TECHNOLOGY LAW, PLLC, 3595 N. SUNSET WAY, SANFORD, MI, 48657, US

(21) Appl. No.: 10/767,567

(22) Filed: Jan. 29, 2004

(51) Int. Cl. C08G 69/08

(52) U.S. Cl. 525/437; 528/354; 428/480

(57) ABSTRACT

Heterocycle terminated dendritic polymers. More specifically, the production of 2-pyrrolidone, 2-piperidone, 2-aza-cycloheptanone or 2-azetidinone-terminated dendritic polymers obtained by reacting precursor primary amine,(e.g., —NH₂)-terminated dendritic polymers with certain functionalized methacrylate reagents to produce new and novel dendritic polymers terminated with ester substituted 2-pyrrolidone, 2-piperidone, 2-aza-cycloheptanone or 2-azetidinone groups.

The present invention relates to heterocycle terminated dendritic polymers. More specifically, the present invention relates to the production of 2-pyrrolidone, 2-piperidone, 2-aza-cycloheptanone or 2-azetidinone-terminated dendritic polymers obtained by reacting precursor primary amine,(e.g., —NH₂)-terminated dendritic polymers with certain functionalized methacrylate reagents to produce new and novel dendritic polymers terminated with ester substituted 2-pyrrolidone, 2-piperidone, 2-aza-cycloheptanone or 2-azetidinone groups. These heterocyclic functionalities are referred to herein collectively as “idones”.

This invention contemplates the preparation of dendritic polymers; wherein, the precursor amine functionalized dendritic polymers are reacted with sub-stoichiometric amounts of functionalized methacrylate reagents to produce dendritic polymers possessing “mixed termini” of 2-pyrrolidone, 2-piperidone, 2-aza-cycloheptanone or 2-azetidinone and residual primary amine (—NH₂) groups.

This invention further embodies the reaction of these “idone-terminated” polymers with ester or amine reactive reagents to provide new and novel “mixed functionality” dendritic polymeric materials.

### BACKGROUND OF THE INVENTION

Precursor dendritic polymers are known in the art and are discussed extensively in DENDRIMERS AND OTHER DENDRITIC POLYMERS, Tomalia, D., and Frechet, J., (2001) John Wiley & Sons, Ltd, New York, N.Y. Dendritic polymers have become recognized as the fourth and most recently reported major class of polymeric architecture (J. Polym. Sci., Part A: Polym. Chem.: 40, 2719-2728 (2002). This dendritic architectural class presently consists of four principal sub-classes; namely, random hyperbranched polymers, dendrigraft polymers, dendrons, and dendrimers. Since the discovery of dendrimers, over fifty different compositional families of dendritic polymers have been reported. For purposes of this invention, what is meant by “dendritic polymers” herein are (a) the random hyperbranched polymers, (b) the dendrigraft polymers, (c) the dendrons, and (d) the dendrimers, and they will be hereinafter referred to as “dendritic polymers.” FIG. 1 illustrates these dendritic polymers which are arranged in increasing order of structural control from left to right.

Random hyperbranched polymers are highly branched macromolecules usually obtained from a “one-pot” polymerization reaction of an AB_{w} type of monomer, that is, ₙAB_{w}-) - - - (AB_{w})ₙ - - - wherein A and B represent mutually reactive functional groups of the monomer and W=2 or greater. They are usually less precise and different from dendrons or dendrimers, in that, random hyperbranched macromolecules are considerably more variable in their structure, possessing a lower degree of branching, and usually exhibiting a high level of polydispersity. Not all random hyperbranched structures of a given hyperbranched polymer population are of the same molecular weight or chain connectivity.

Dendrimers, on the other hand and are described as globular, nano-scale core-shell type macromolecules. They consist of two or more “tree-like dendrons,” emanating from a single central atom, atomic cluster or molecular structure called the core. They are comprised of radial layers of “branch cells” that are the main building blocks or repeat units of the dendritic structures. They are organized in mathematically precise dendritic (i.e., branch upon branch) type architectural arrangements, that give rise to a series of regular radially concentric layers of branch cells around the core, called generations (G). Dendrimers consist of three architectural components that include: (1) a core, (2) interior branch cells, and (3) surface or exterior branch cells.

Dendrons are the smallest constitutive components of a dendrimer that exhibit the same dendritic architectural arrangement as the dendrimer itself and are reminiscent of “a molecular tree.” They may emanate from a single trunk or branch that terminates with “leaf-like” terminal functional groups that may be either reactive or inert.

With regard to the dendrigraft polymers, they are derived from dendritic arrays of linear repeat unit segments that form branch cells and usually manifest covalent connectivity relative to some interior molecular reference marker or core. As such, these branch cell arrays may be very non-ideal and polydispersed, that is, M_{w}/Mₙ=2 to 10, as observed for random hyperbranched polymers, or very ideally organized into highly controlled core-shell type structures as noted for dendrons/dendrimers, that is, M_{w}/Mₙ=1.01-1.0001 and less. Dendrigraft polymers reside between these two extremes of structure control, frequently manifesting rather narrow polydispersities of M_{w}/Mₙ=1.1 to 1.5, depending on their mode of preparation.

The most extensively investigated dendrimer family is the poly(amidoamine) (“PAMAM”) series. The PAMAM dendrimers are sold by Dendritic Nanotechnologies Inc., Mt. Pleasant, Mich., and are generally manufactured by the use of a two-step process. An example of this two-step process is illustrated in FIG. 2. The first step (a) of the two step process is generally referred to as amplification and is an alkylation step that involves the exhaustive Michael addition of alkyl acrylates to the active hydrogens of various amine cores, resulting in ester-terminated Michael adducts. In FIG. 2 (a), methyl acrylate is added to a generation n (Gₙ) dendrimer terminated with primary amine (—NH₂). In FIG. 2(a), the Michael addition of methyl acrylate produces a half generation, that is, Gₙ=0.5 of a dendrimer with the ester groups equal to —CO₂CH₃. The second step (b) of the two-step process is an amidation step that involves amidation of the ester-terminated adducts resulting from the first step with an excess of ethylenediamine. In FIG. 2(b), the addition of ethylenediamine results in a generation (n+1) dendrimer terminated with primary amine (—NH₂). Each iteration of the two-step process produces an amplification of terminal groups according to Z=N_{c}N_{b}; where Z=theoretical number of terminal groups expected at a defined generation level. The number of terminal groups is determined by N_{c}=core multiplicity, N_{b}=branch multiplicity and (G), the generation level. This two-step process is sometimes referred to as dendronization, or, in other words, a dendrimer having a particular generation Gₙ can be dendronized or amplified to produce a dendrimer of generation Gₙ₊₁.

Earlier attempts to extend the breadth of the two-step process for producing PAMAM dendrimers by utilizing conventional alkyl methacrylates instead of alkyl acrylates in the first step of the process have been largely unsuccessful due to significant retro-Michael reactions to produce complex mixtures of products.

It has been recently determined that certain methacryl derivatives undergo a surprising Michael addition reaction to a variety of primary amine-terminated dendritic polymers followed by ring closure to give very high yields of white, solid, substituted 2-pyrrolidone, 2-piperidone, 2-aza-cycloheptanone or 2-azetidinone products.

### The Invention

In one embodiment, the present invention provides a dendritic polymer having a formula selected from the group consisting of D_{G}(Q)_{z}, D_{G}(NH₂)_{z-x}(Q)ₓ, and D_{G}(Q)_{z-x}(Q′)ₓ wherein D_{G} is a dendritic polymer, _{G} is the generation number of the dendritic polymer, x has a value of from 1 to (z−1), z is an integer less than or equal to N_{c}.N_{b}^{G}, wherein; N_{c} is core multiplicity, N_{b} is branch cell multiplicity, Q has the general formula 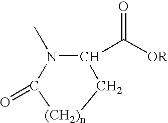
wherein, n has a value of from zero to 3, Q′ has the general formula 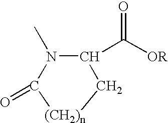
wherein, n has a value of from zero to 3, and wherein the value of n in Q′ is different than the value of n in Q, and wherein R is selected from the group consisting of hydrogen, alkyl groups having from 1 to 18 carbon atoms and aryl groups having from 6 to 12 carbon atoms.

In another embodiment of this invention, there is provided processes for the preparation of the dendritic polymers, and still further, there is provided processes for the further modification of such polymers to provide new and novel materials.

The modification includes a process for preparing a dendritic polymer, the process comprising (I) providing a precursor primary amine functional dendritic polymer having the general formula D_{G}(NH₂)_{z}; (II) contacting the precursor primary amine functional dendritic polymer with a reagent having the general formula: RO₂CC(═CH₂)(CH₂)ₙCO₂R wherein R is selected from the group consisting of hydrogen, or alkyl groups having from 1 to 18 carbon atoms or aryl groups having from 6 to 12 carbon atoms; (III) reacting (I) and (II) for a time sufficient and at a temperature sufficient to provide a dendritic polymer having the general formula selected from the group consisting of D_{G}(Q)_{z}, D_{G}(NH₂)_{z-x}(Q)ₓ, or D_{G}(Q)_{z-x}(Q′)ₓ wherein; D_{G} is a dendritic polymer, _{G} is the generation number of the dendritic polymer, x has a value of 1 to (z−1), z is an integer less than or equal to N_{c}.N_{b}^{G} wherein N_{c} is core multiplicity, N_{b} is branch cell multiplicity, Q has the general formula: 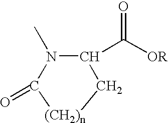
wherein n has a value of from zero to 3, Q′ has the general formula: 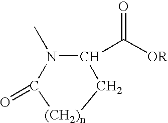
wherein n has a value of from zero to 3, wherein the value of n in Q′ is different than the value of n in Q, and wherein R is selected from the group consisting of hydrogen, alkyl groups having from 1 to 18 carbon atoms or aryl groups having from 6 to 12 carbon atoms. FIG. 3 illustrates the functionalities that result when the values of n=0 to 3.

Another embodiment of this invention is a process for preparing a functionalized material, the process comprising (I) providing a precursor primary amine functional dendrimer having the general formula D_{G}(NH₂)_{z}; (II) contacting the precursor primary amine functional dendrimer with a sub-stoichiometric quantity of a material having the general formula RO₂CC(CH₂)ₙCO₂R wherein R is selected from the group consisting of hydrogen, alkyl groups having from 1 to 18 carbon atoms and aryl groups having from 6 to 12 carbon atoms; (III) reacting (I) and (II) for a time sufficient and at a temperature sufficient to provide a dendritic polymer having the general formula selected from the group consisting of D_{G}(NR″₂)_{z-x}(Q)ₓ, wherein D_{G} is a dendritic polymer, _{G} is the generation number of the dendritic polymer, x has a value of 1 to (z−1), z is an integer less than or equal to N_{c}.N_{b}^{G}, wherein N_{c} is core multiplicity, N_{b} is branch cell multiplicity, and Q has the general formula 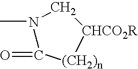
wherein n has a value of from zero to 3 and wherein R is selected from the group consisting of hydrogen, alkyl groups having from 1 to 18 carbon atoms and aryl groups having from 6 to 12 carbon atoms, and reacting the product from (iii) with material that will react with residual amine groups in the dendritic polymer to provide a functional group selected from the group consisting of (a) hydrophobic groups and (b) hydrophilic groups.

A further embodiment of this invention is a process for preparing a functionalized material, the process comprising (I) providing a precursor primary amine functional dendrimer having the general formula D_{G}(NH₂)_{z}; (II) contacting the precursor primary amine functional dendrimer with a mixture of materials having the general formula RO₂CC(CH₂)ₙCO₂R wherein each of the materials have a different value for n, and wherein R is selected from the group consisting of hydrogen, alkyl groups having from 1 to 18 carbon atoms and aryl groups having from 6 to 12 carbon atoms; (III) reacting (I) and (II) for a time sufficient and at a temperature sufficient to provide a dendritic polymer having the general formula D_{G}(Q)_{z-x}(Q′)ₓ wherein D_{G} is a dendritic polymer, _{G} is the generation number of the dendritic polymer, x has a value of 1 to (z−1), z is an integer less than or equal to N_{c}.N_{b}^{G}, wherein N_{c} is core multiplicity, N_{b} is branch cell multiplicity, Q has the general formula 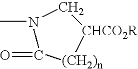
wherein n has a value of from zero to 3, Q′ has the general formula: 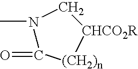
wherein n has the value of 0 to 3 and wherein the value of n is different than the value of n in Q, and wherein R is selected from the group consisting of hydrogen, alkyl groups having from 1 to 18 carbon atoms and aryl groups having from 6 to 12 carbon atoms.

The modification includes a process for preparing a dendritic polymer, the process comprising (I) providing a precursor primary amine functional dendrimer having the general formula D_{G}(NH₂)_{z}; (II) contacting the precursor primary amine functional dendrimer with a material having the general formula: RO₂CC(CH₂)ₙCO₂R wherein R is selected from the group consisting of hydrogen, alkyl groups having from 1 to 18 carbon atoms and aryl groups having from 6 to 12 carbon atoms; (III) reacting (I) and (II) for a time sufficient and at a temperature sufficient to provide a dendritic polymer having the general formula selected from the group consisting of D_{G}(Q)_{z}, D_{G}(NH₂)_{z-x}(Q)ₓ, and D_{G}(Q)_{z-x}(Q′)ₓ wherein D_{G} is a dendritic polymer, _{G} is the generation number of the dendritic polymer, x has a value of 1 to (z−1), z is an integer less than or equal to N_{c}.N_{b}^{G} wherein N_{c} is core multiplicity, N_{b} is branch cell multiplicity, and Q has the general formula: 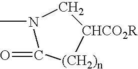
wherein n has a value of from zero to 3 and wherein R is selected from the group consisting of hydrogen, alkyl groups having from 1 to 18 carbon atoms and aryl groups having from 6 to 12 carbon atoms.

Yet another embodiment of this invention provides for dendritic polymers that have been modified according to the embodiment set forth just above, and in addition, the further modification of such modified polymers by reacting the polymers with mono- or multi-functional reactive materials to provide “mixed terminal functionality.”

### BRIEF DESCRIPTION OF THE DRAWINGS

FIG. 1 is an illustration of the four dendritic architectures

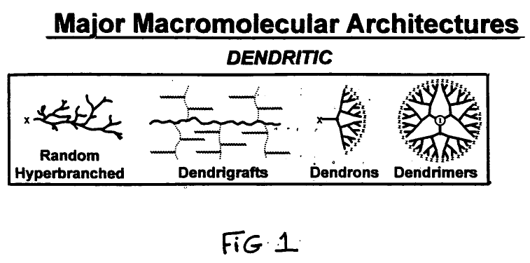

FIG. 2 is an illustration of the prior art two-step process for producing a precursor dendritic polymers terminated with primary amine functionalities.

FIG. 3 is an illustration of the general structure and products that result when the value of n is 0 to 3.

FIG. 4 illustrates a proposed two step process for producing a 4-carbomethoxy-2-pyrrolidone-terminated dendritic polymer of this invention.

FIG. 5 illustrates the reaction of 4-carbomethoxy-2-pyrrolidone with a multi-functional amine such as (TREN); tris(2-aminoethyl) amine to produce a diamino(amide) functionality.

FIG. 6 illustrates thin-layer chromatography(TLC) results for (saturated idone) type;(G=0-5); PAMAM dendrimer terminated with 4-carbomethoxy-2-pyrrolidones functionality according to this invention.

FIG. 7 illustrates thin layer chromatography (TLC) results for (sub-saturated idone) type; (G=0); PAMAM dendrimers terminated with 4-carbomethoxy-2-pyrrolidone functionality and residual amine groups.

FIG. 8, illustrates the combinatorial possibilities for producing dendritic polymers (D_{G}) with “mixed terminal functionality” derived from various (sub-saturated idone) type polymers.

### DETAILED DESCRIPTION OF THE INVENTION

Earlier attempts to extend the breadth of the two step process for producing PAMAM dendrimers by utilizing alkyl methacrylates, instead of alkyl acrylates, in the first step of the process have been unsuccessful. The use of alkyl methacrylates was unsuccessful due to incomplete Michael adduct formation with primary amines. Under a variety of conditions, alkyl acrylates underwent high yield exhaustive Michael addition reactions at each active hydrogen site with a variety of primary amine-terminated dendritic polymers. However, under the same conditions, the corresponding alkyl methacrylates did not undergo efficient Michael addition reactions and exhibited a strong tendency to retro-Michael. When two equivalents of methyl methacrylate per primary amine group were reacted at 40° C. for 48 hours on a full generation dendrimer, only one equivalent of methyl methacrylate per amine site was added to the dendrimer. When five equivalents of methyl methacrylate per primary amine group were reacted under the same conditions, the same product was obtained.

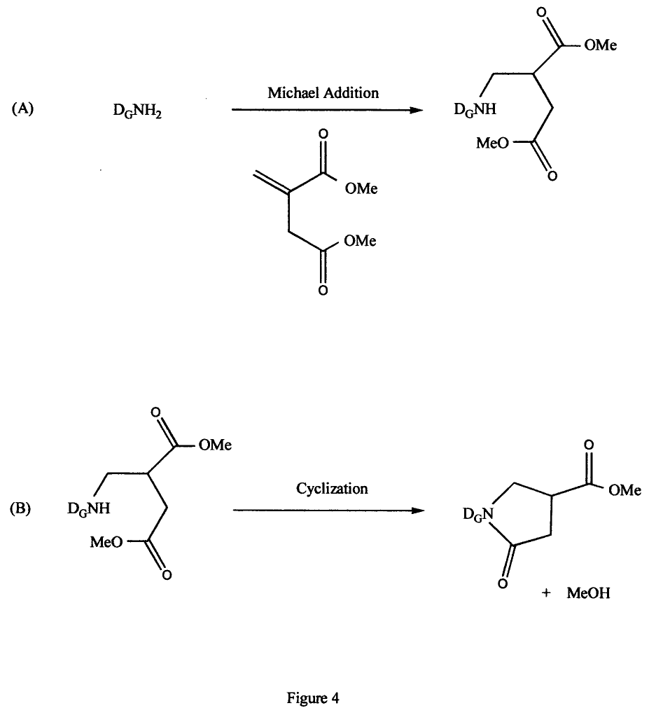

It has now been determined that certain functionalized methacrylate derivatives react with a variety of primary amine-terminated dendritic polymers to give very high yields of white, solid, substituted 2-pyrrolidone, 2-piperidone, aza-2-cycloheptanone or 2-azetidinone products. Formation of the cyclic terminated products appears to occur via aa two-step process. The first step involves the Michael addition of the methacrylate-type double bond to an active hydrogen of the primary amine terminated dendritic polymer as shown in FIG. 4, line A), followed by cyclization with elimination of a low molecular weight by-product. In this case an alcohol fragment is eliminated to produce a novel substituted product, in this case 2-pyrrolidone terminated product, as shown in FIG. 4, line B).

As set forth above, one embodiment of this invention is the provision of a 2-pyrrolidone, 2-piperidone, aza-2-cycloheptanone or 2-azetidinone-terminated dendritic polymer having the formula selected from the group consisting of:
D_{G}(Q)_{z}, D_{G}(NH₂)_{z-x(Q)}ₓ, or D_{G}(Q)_{z-x}(Q′)ₓ
   wherein, D_{G} is a dendritic polymer, _{G} is the generation number of the dendritic polymer, x has a value of from 1 to (z−1), z is an integer less than or equal to N_{c}.N_{b}^{G}, wherein N_{c} is core multiplicity, N_{b} is branch cell multiplicity, and Q has the general formula: 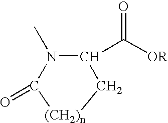
   wherein n has a value of from zero to 3 and wherein R is selected from the group consisting of hydrogen, alkyl groups having from 1 to 18 carbon atoms or aryl groups having from 6 to 12 carbon atoms.

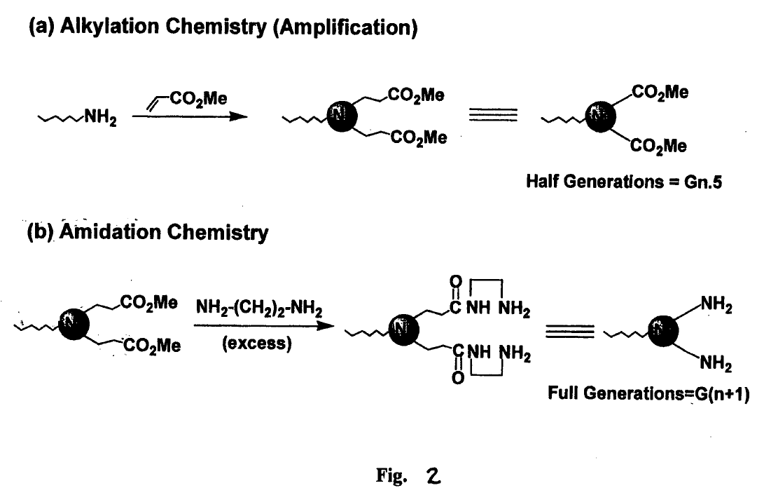

Core multiplicity, that is, N_{c} and branch cell multiplicity, that is N_{b} are terms known in the art, cf. Tomalia, Supra. Core multiplicity refers to the number of dendrons that can be anchored to the core. For example, an ethylenediamine core has a core multiplicity of 4 and an ammonia core has a core multiplicity of 3. Branch cell multiplicity determines the density and degree of amplification as an exponential function of generation. For example, the branch cell multiplicity in FIG. 2 is two. That is, for each generation produced according to FIG. 2, the number of terminal groups is doubled.

The dendritic polymers of the present invention can be produced by reacting various functionalized methacrylate derivatives with precursor primary terminated dendritic polymers. The methacrylate derivatives have the general formula D_{G}(Q)_{z}, wherein _{G} and _{z} are defined above.

For purposes of this invention, the materials for reacting with the primary amine-terminated precursor dendritic polymers may be selected from the following: itaconic acid (i.e., methylene succinic acid), and its esters; methylene glutaric acid and, its esters; or methylene malonic acid, and its esters.

For purposes of this invention, R is selected from the group consisting of hydrogen, alkyl groups having from 1 to 18 carbon atoms or aryl groups possessing from 6 to 12 carbon atoms. When R is selected from hydrogen, the group is hydroxyl and when R is selected from either alkyl or aryl groups, the group is an ester.

Representative of the alkyl groups are those groups having from 1 to 18 carbon atoms (i.e., methyl, ethyl, propyl and butyl, decyl, dodecyl and octadecyl), the preferred being methyl or ethyl, and most preferred being methyl.

Aryl groups that can be used in this invention are substituted and unsubstituted aryl groups, the preferred aryl groups being unsubstituted aryl groups, and the most preferred being the phenyl group.

Thus, specific reagents such as the following can be used in this invention. RO₂C C(═CH₂)CO₂R; RO₂C C(═CH₂)CH₂CO₂R; RO₂C—C(═CH₂)CH₂ CH₂—CO₂R;

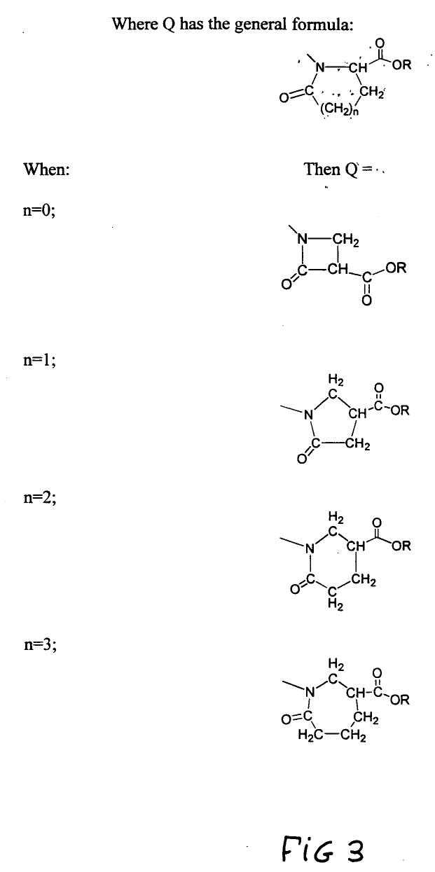

RO₂C—C(═CH₂)CH₂CH₂CH₂CO₂R; wherein each R is selected from hydrogen, alkyl groups of 1 to 18 carbon atoms or aryl groups possessing 6 to 12 carbons. Heterocyclic groups (Q) that can be formed are as illustrated in FIG. 3

The reactions are carried out with the reactants being present in stoichiometric equivalents based on primary amines or slight excess, wherein, the theoretical amount of Q_{z} groups would be formed at the termini as determined by Z=N_{c}N^{G}. Alternatively, sub-stoichiometric amounts of reagents may be used with the dendritic polymer substrates which would produce dendritic polymers with less than the stoichiometric saturation level of Q groups at their termini. That is to say, D_{G}−(Q)_{z-x}; where x is 0.1Z-0.9Z. The unreacted amines from these sub-stoichiometric reactions can be further functionalized with hydrophilic or hydrophobic acrylates, epoxides or acids, however, not limited by this list to form “mixed functionality” dendritic polymer surfaces.

The reactions can be carried out neat, that is, without the use of solvents, or appropriate solvents can be used as desired. The temperatures at which the reactions are carried out range from −15° C. to about 160° C. and are usually run under an inert atmosphere. In the case of the esters the reaction should be run in inert, dry atmospheres. These reactions normally require from 30 minutes to about 72 hours to complete, depending on the particular combination of materials being reacted.

In another embodiment of this invention, there is contemplated a modification of the resulting ester modified heterocyclic terminal groups by the use of modifying reagents that are reactive with the heterocyclic bearing ester or carboxylic acid groups. These reagents may be mono-functional or multi-functional reactive reagents.

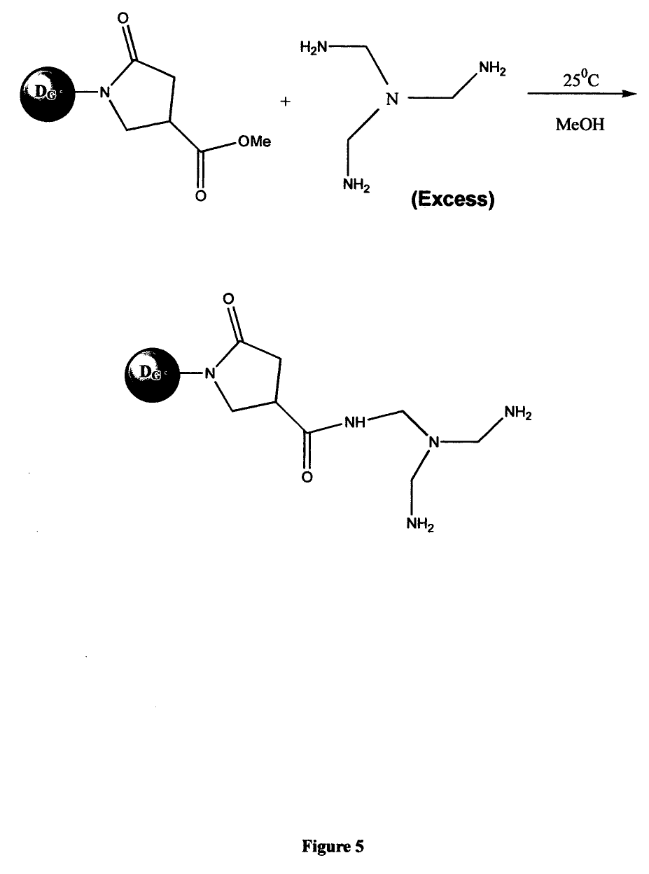

For example, tris(aminoethyl)amine (TREN), a multi-functional reagent can be reacted with ester functionalized, pyrrolidone terminated polymer, according to the reaction scheme of FIG. 5, to produce a diamino(amido) pyrrolidone polymer. It is understood that any mono or multi-functional material that is reactive with the ester functionalized 2-pyrrolidone, 2-piperidone, aza-2-cycloheptanone or 2-azetidinone polymers may be used (FIG. 5).

### EXAMPLES

### Example 1

General Procedure for Preparation of 4-Carbomethoxy-2-Pyrrolidone Terminated Poly(amidoamine) (PAMAM) Dendrimers

Dimethyl itaconate (97%), available from Acros, Morris Plains, N.J. was first added to a 50 ml, round-bottomed flask containing a magnetic stirring bar. The amount of dimethyl itaconate added was equal to about 1 equivalent per terminal amino group to be added. Next, 2 ml of methanol was added to the round-bottomed flask for each gram of dimethyl itaconate added. This mixture of dimethyl itaconate and methanol was stirred to a homogenous state and cooled to 0° C. using an ice-water bath. To this stirred mixture was added a 15% by weight solution of PAMAM dendrimer in methanol. The PAMAM dendrimers utilized were all produced from a diaminobutane (“DAB”) core. The solution of PAMAM dendrimer in methanol was added dropwise while stirring over a 10 minute period. The reaction mixture was allowed to warm to room temperature and stirred for an additional 48 hours. The reaction mixture was then ultrafiltered as a 5% by weight solution with regenerated cellulose membrane in Methanol to give four retentate volumes of permeate. The retentate was then filtered through a course glass filter. The solvent was then removed, yielding a white solid product. This procedure was followed using six different generation (generation 0 through generation 5) of DAB-core PAMAM dendrimers.

The yield for the above procedure was calculated based on a mole of starting material. The yield results for each of the six generations are shown in Table 1. In Table 1, Z represents the number of substituted-pyrrolidone surface groups on the resulting pyrrolidone-terminated: (DAB-core) PAMAM dendrimers. Molecular formula of the resulting pyrrolidone-terminated (DAB-core) PAMAM dendrimers and MW is the molecular weight of the resulting pyrrolidone-terminated (DAB-core) PAMAM dendrimers. This series represent examples of the (saturated idone) dendritic polymers.

TABLE 1

| | Surface | | | Yield |
|---|---|---|---|---|
| Generation | Groups (Z) | Molecular Formula | MW | (%) |
| 0 | 4 | C₄₈H₇₈N₁₀O₁₆ | 1,051 | 98 |
| 1 | 8 | C₁₁₂H₁₈₀N₂₆O₃₆ | 2,467 | 95 |
| 2 | 16 | C₂₄₀H₃₈₈N₅₈O₇₆ | 5,302 | 99 |
| 3 | 32 | C₄₉₆H₈₀₄N₁₂₂O₁₅₆ | 10,973 | 95 |
| 4 | 64 | C₁₀₀₈H₁₆₃₆N₂₅₀O₃₁₆ | 22,313 | 94 |
| 5 | 128 | C₂₀₃₂H₃₃₀₀N₅₀₆O₆₃₆ | 44,995 | 94 |

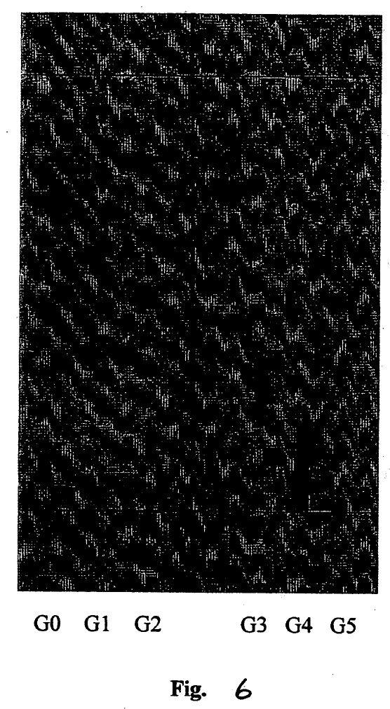

Pyrrolidone-terminated polymers of the present invention are more easily separated and purified using thin-layer chromatography (“TLC”), than the corresponding amine terminated polymers from which they are produced. For example, amine terminated PAMAM dendrimers, tend to stick tenaciously to (TLC) silica gel plates. Therefore, TLC chromatograms of —NH₂-terminated PAMAM dendrimers usually exhibit very low R_{f} values and extensive tailing. Including ammonium hydroxide in the elution solvent allows separation and purification of low generation (G=0-1) amine terminated dendrimers by TLC. However, modifying the —NH₂ surface groups to substituted pyrrolidone in accordance with the present invention, changes the polarity and mobility of these polymers substantially. Accordingly, the TLC plates of pyrrolidone-terminated polymers of the present invention allows separation and purification of a much wider range of generations; namely, (G=0-5) as illustrated in FIG. 6.

TLC studies were performed on (DAB-core); PAMAM dendrimers that had been terminated with 4-carbomethoxy-2-pyrrolidone in accordance with the present invention. The solvent system utilized was a mixture of dichloromethane, methanol, and ammonium hydroxide in a ratio of 3:1:0.02, respectively. The studies were performed on dendrimers of generation 0 through generation 5 and the results are shown in FIG. 6. The corresponding R_{f} values are shown in Table 2

TABLE 2

| Generation | R_{f} Value |
|---|---|
| G0 | 0.67 |
| G1 | 0.57 |
| G2 | 0.49 |
| G3 | 0.34 |
| G4 | 0.18 |
| G5 | 0.00 |
| | (approximately) |

### Example 2

Reaction of Amine Terminated PAMAM Dendrimer with Sub-Stoichiometric Amounts of Functionalized Methacrylate Reagents to Produce “Mixed Terminal Functionality”

Additional TLC studies were performed on (DAB-core); PAMAM dendrimers that had been terminated with 4-carbomethoxy-2-pyrrolidone in accordance with the present invention. In these studies, the dendrimers were all generation=0. The initial —NH₂-terminated (DAB-core); PAMAM dendrimers were reacted with dimethyl itaconate by utilizing the same general reaction procedure described above. Four different batches of samples (Samples 1 to 4) were produced by allowing the initial amine terminated dendrimers to react with four different amounts of dimethyl itaconate. The amounts of methyl itaconate utilized were 1 equivalent (Sample 1), 2 equivalents (Sample 2), 3 equivalents (Sample 3), and 4 equivalents (Sample 4).

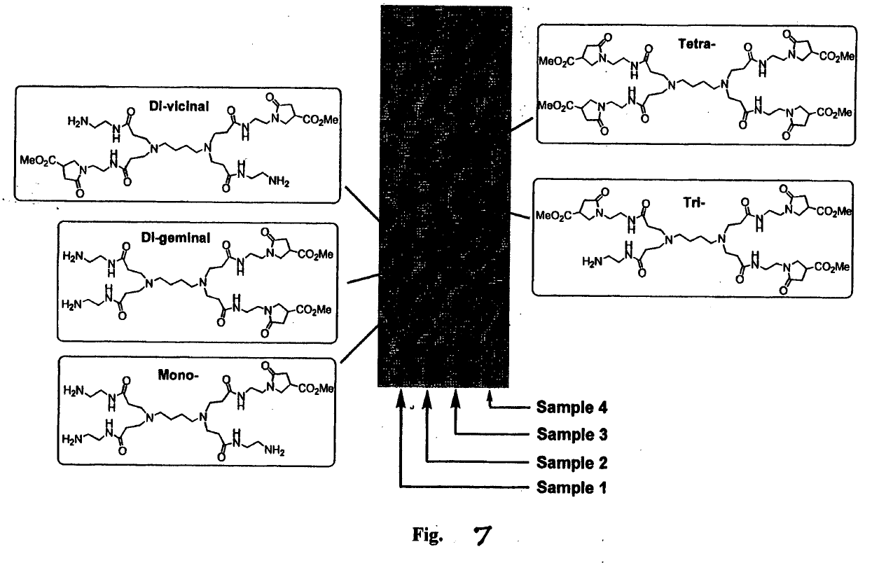

Samples 1 to 4 were all subjected to silica gel TLC studies utilizing the same solvent mixture identified above. The results are shown in FIG. 7.

As illustrated in FIG. 7, the resulting samples contained varying amounts of pyrrolidone substitution. The amount of pyrrolidone substitution increases as a function of the amount of methyl itaconate used. Accordingly, Sample 1 with 1 equivalent of methyl itaconate contains little or no tetra-substituted dendrimers and Sample 4 with 4 equivalents of methyl itaconate contains all or nearly all tetra-substituted dendrimers. Sample 2 with 2 equivalents of methyl itaconate and Sample 3 with 3 equivalents of methyl itaconate contain higher amounts of di- and tri-substituted dendrimers. Sample 2 contains more mono and di-substituted whereas Sample 3 contains more tri-substituted dendrimer. The TLC results also indicate that the yield of di-vicinal substituted dendrimers is higher than that of di-geminal substituted dendrimers. This higher yield indicates that steric interaction between the surface groups at the same side of the molecule plays a role in the reaction. FIG. 7 illustrates these various (sub-saturated idone) type polymers.

The TLC results shown in FIG. 7 further indicate that he mono, di-, tri-, and tetra-substituted dendrimers are readily separated by TLC. Additionally, the two di-substituted isomers, that is, vicinal and geminal are also separated by TLC. This is undoubtedly because the two isomers have slightly different polarities.

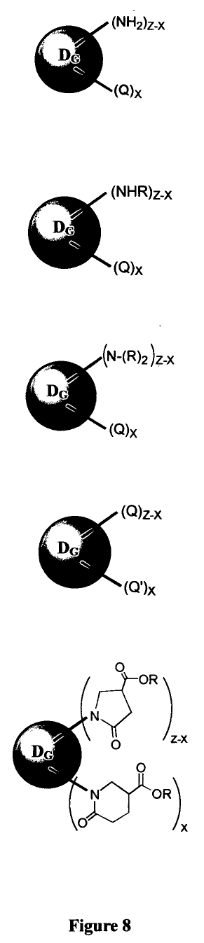

Accordingly, it has been shown, herein, that dendritic polymers can be produced that possess 2-pyrrolidone, 2-piperidone,2-aza-cycloheptanone or 2-azetidinone functionality as terminal groups by reacting —NH₂ terminal groups with various functionalized methacrylate derivatives. It has also been shown that dendritic polymers possessing varying amounts of pyrrolidone terminal groups (i.e., sub-saturated idones) type structures can be produced by reacting —NH₂-terminated dendritic polymers with less than the theoretical amount of functionalized methacrylate reagent required to convert all of the —NH₂ groups. Dendritic polymers having substantially all terminal groups comprising pyrrolidone, or like groups will be referred to herein as “idone” or “(saturated) idones” Dendritic polymers having only a fraction of the terminal groups comprising the idone groups will be referred to herein as (sub-saturated) “idones”. FIG. 8 illustrates the combinatorial possibilities for producing dendritic polymers with “mixed terminal functionality” derived from various (sub-saturated idone) type polymers.

Finally, is has been shown that the ester substituents on the heterocyclic terminal groups of the dendritic polymers can be reacted with mono or multi-functional reagents (e.g. amines) and allow introduction of various amine functionalities. Example 3 illustrates such a transformation with tris(2-aminoethyl)amine (TREN) to produce a diamino(amido) moiety as described in FIG. 5.

### Example 3

Reaction of 4-Carboxymethyl-2-Pyrrolidone Terminated PAMAM Dendrimer with tris(2-aminoethyl)amine (TREN)

To a 25 ml, one-necked round bottom flask with a stir bar was added (8.5 g., 58.2 mmoles, 10 equivalents per ester) and 2 g. of methanol. To this mixture cooled to 5° C. was added dropwise, 4-carbomethoxy-2-pyrrolidone modified, (EDA core), (G=3), PAMAM dendrimer (2.0 g., 0.184 mmoles, 5.8 mmoles ester) in 5 g. of methanol. This mixture was stirred at 25° C. for 3 days under nitrogen. An infrared spectrum of this material indicated the complete disappearance of the ester carbonyl group at 1735 cm⁻¹. This mixture was diluted to 5% w/w in deionized water and ultrafiltered using a 3000 molecular weight cutoff, regenerated cellulose membrane to give 12 retentate recirculations of permeate. The retentate was filtered and evaporated of volatiles on a rotary evaporator. This residue was further evacuated at high vacuum to a constant weight to give 2.7 g. (98%) yield) of the desired product.

1. A dendritic polymer having a formula selected from the group consisting of:
D_{G}(Q)_{z}, D_{G}(NH₂)_{z-x}(Q)ₓ, and D_{G}(Q)_{z-x}(Q′)ₓ
wherein D_{G} is a dendritic polymer, _{G} is the generation number of the dendritic polymer, x has a value of from 1 to (z−1), z is an integer less than or equal to N_{c}.N_{b}^{G}, wherein N_{c} is core multiplicity, N_{b} is branch cell multiplicity, Q has the general formula: 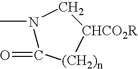
wherein n has a value of from zero to 3 Q′, has the general formula: 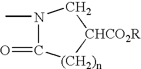
wherein n has a value of from zero to 3, wherein the value of n in Q′ is not the same as the value of n in Q, and wherein R is selected from the group consisting of hydrogen, alkyl groups having from 1 to 18 carbon atoms and aryl groups having from 6 to 12 carbon atoms.

2. A process for preparing a dendritic polymer, the process comprising:
(I) providing a precursor primary amine functional dendrimer having the general formula:
D_{G}(NH₂)_{z};
(II) contacting the precursor primary amine functional dendrimer with a material having the general formula:
RO₂CC(CH₂)ₙCO₂R
wherein R is selected from the group consisting of hydrogen, alkyl groups having from 1 to 18 carbon atoms and aryl groups having from 6 to 12 carbon atoms;
(III) reacting (I) and (II) for a time sufficient and at a temperature sufficient to provide a dendritic polymer having the general formula selected from the group consisting of
D_{G}(Q)_{z},
wherein D_{G} is a dendritic polymer, _{G} is the generation number of the dendritic polymer, z is an integer less than or equal to N_{c}.N_{b}^{G}, wherein N_{c} is core multiplicity, N_{b} is branch cell multiplicity, and Q has the general formula: 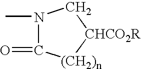
wherein n has a value of from zero to 3 and wherein R is selected from the group consisting of hydrogen, alkyl groups having from 1 to 18 carbon atoms and aryl groups having from 6 to 12 carbon atoms.

3. A dendritic polymer prepared by the process of claim 2

4. A process for preparing a dendritic polymer, the process comprising:
(I) providing a precursor primary amine functional dendrimer having the general formula:
D_{G}(NH₂)_{z};
(II) contacting the precursor primary amine functional dendrimer with a sub-stoichiometric quantity of a material having the general formula:
RO₂CC(CH₂)ₙCO₂R
wherein R is selected from the group consisting of hydrogen, alkyl groups having from 1 to 18 carbon atoms and aryl groups having from 6 to 12 carbon atoms;
(III) reacting (I) and (II) for a time sufficient and at a temperature sufficient to provide a dendritic polymer having the general formula
D_{G}(NR″₂)_{z-x}(Q)ₓ,
wherein D_{G} is a dendritic polymer, _{G} is the generation number of the dendritic polymer, x has a value of 1 to (z−1), z is an integer less than or equal to N_{c}.N_{b}^{G}, wherein N_{c} is core multiplicity, N_{b} is branch cell multiplicity, and Q has the general formula: 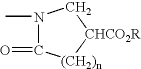
wherein n has a value of from zero to 3 and wherein R is selected from the group consisting of hydrogen, alkyl groups having from 1 to 18 carbon atoms and aryl groups having from 6 to 12 carbon atoms and R″ is selected from the group consisting of hydrophobic groups, hydrophilic groups, hydrogen, hydroxyl groups, and alkyl groups having 1 to 18 carbon atoms.

5. A dendritic polymer prepared by the process of claim 4.

6. A process for preparing a functionalized material, the process comprising:
(I) contacting a dendritic polymer as claimed in claim 5 with a polyfunctional amine;
(II) contacting the product from (I) with additional pyrrolidone, piperidone, or azetidinone-terminated dendritic polymers.

7. A dendritic polymer prepared by the process of claim 6.

8. A process for preparing a functionalized material the process comprising:
(I) providing a precursor primary amine functional dendrimer having the general formula:
D_{G}(NH₂)_{z};
(II) contacting the precursor primary amine functional dendrimer with a sub-stoichiometric quantity of a material having the general formula:
RO₂CC(CH₂)ₙCO₂R
wherein R is selected from the group consisting of hydrogen, alkyl groups having from 1 to 18 carbon atoms and aryl groups having from 6 to 12 carbon atoms;
(III) reacting (I) and (II) for a time sufficient and at a temperature sufficient to provide a dendritic polymer having the general formula selected from the group consisting of
D_{G}(NR″₂)_{z-x}(Q)ₓ,
wherein D_{G} is a dendritic polymer, _{G} is the generation number of the dendritic polymer, x has a value of 1 to (z−1), z is an integer less than or equal to N_{c}.N_{b}^{G} , wherein N_{c} is core multiplicity, N_{b} is branch cell multiplicity, and Q has the general formula: 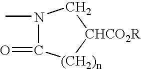
wherein n has a value of from zero to 3 and wherein R is selected from the group consisting of hydrogen, alkyl groups having from 1 to 18 carbon atoms and aryl groups having from 6 to 12 carbon atoms, and reacting the product from (iii) with material that will react with residual amine groups in the dendritic polymer to provide a functional group selected from the group consisting of (a) hydrophobic groups and (b) hydrophilic groups.

9. A process as claimed in claim 8 wherein (a) and (b) are selected from the group consisting of (i) acrylates, (ii) epoxides, and (iii) acids.

10. A dendritic polymer prepared by the process of claim 8.

11. A dendritic polymer prepared by the process of claim 9.

12. A process for preparing a functionalized material, the process comprising:
(I) providing a precursor primary amine functional dendrimer having the general formula:
D_{G}(NH₂)_{z};
(II) contacting the precursor primary amine functional dendrimer with a mixture of materials having the general formula:
RO₂CC(CH₂)ₙCO₂R
wherein each of the materials have a different value for n, and wherein R is selected from the group consisting of hydrogen, alkyl groups having from 1 to 18 carbon atoms and aryl groups having from 6 to 12 carbon atoms;
(III) reacting (I) and (II) for a time sufficient and at a temperature sufficient to provide a dendritic polymer having the general formula
D_{G}(Q)_{z-x}(Q′)ₓ
wherein D_{G} is a dendritic polymer, _{G} is the generation number of the dendritic polymer, x has a value of 1 to (z−1), z is an integer less than or equal to N_{c}.N_{b}^{G} , wherein N_{c} is core multiplicity, N_{b} is branch cell multiplicity, Q has the general formula: 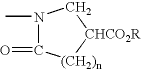
wherein n has a value of from zero to 3, Q′ has the general formula: 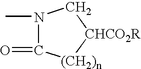
wherein n has the value of 0 to 3 and wherein the value of n in Q′ is different than the value of n in Q, and wherein R is selected from the group consisting of hydrogen, alkyl groups having from 1 to 18 carbon atoms and aryl groups having from 6 to 12 carbon atoms.

13. A dendritic polymer prepared by the process of claim 12.

14. A dendritic polymer as claimed in claim 13 wherein Q is

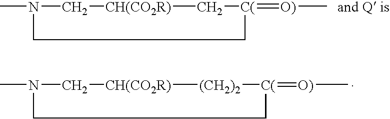

15. A process as claimed in claim 8, wherein D_{G}(Q)_{z-x}(Q′)ₓ is D_{G}(NH₂) Q)_{z-x}(Q′)ₓ.

16. A process as claimed in claim 8, wherein D_{G}(Q)_{z-x}(Q′)ₓ is D_{G}(NHR″) Q)_{z-x}(Q′)ₓ, wherein R″ is either a hydrophobic group or a hydrophilic group and consists of 1 to 18 carbon atoms.

17. A process as claimed in claim 8, wherein D_{G}(Q)_{z-x}(Q′)ₓ is D_{G}(N—(R)₂)_{z-x}(Q′)ₓ, wherein R is either a hydrophobic group or a hydrophilic group and consists of 1 to 18 carbon atoms.

18. A dendritic polymer as claimed in claim 5 wherein R″ is —C—CC(OH)(R′) wherein R′ is selected from the group consisting of hydrogen and alkyl groups of 1 to 18 carbon atoms.

19. A dendritic polymer as claimed in claim 5 wherein R″ is —C(═O)R and R is a long chain acid of up to 18 carbon atoms.
